(19) United States
(12) Patent Application Publication
(10) Pub. No.: US 2006/0215964 A1
(43) Pub. Date: Sep. 28, 2006

(54) Optical element combination structure

(76) Inventors: Toshihiro Kuroda, Tsukuba-shi (JP); Shigeyuki Yagi, Tsukuba-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/442,348

(22) Filed: May 30, 2006

Related U.S. Application Data
(63) Continuation of application No. PCT/JP04/17254, filed on Nov. 19, 2004.

(30) Foreign Application Priority Data
Nov. 28, 2003 (JP) 2003-399287
Mar. 29, 2004 (JP) 2004-95477

(51) Int. Cl. G02B 6/30

(52) U.S. Cl. 385/49

(57) ABSTRACT

An optical element combination structure 1 according to the present invention comprises an optical fiber 2 extending in a direction of an optical axis 1a, an optical waveguide 4 being aligned with the fiber 2 in a direction of the optical axes 1a and having an end surface 18 facing an end surface 12 of the fiber, and a substrate 6 coupled with the fiber 2 and the waveguide 4. The end surface 12 of the fiber 2 is formed perpendicular to the optical axis 1a, and the end surface 18 of the waveguide 4 is inclined relative to a surface perpendicular to the optical axis 1a. A value of refractive index of a core 12 of the fiber 2 is different from that of refractive index of a core 14 of the waveguide 4. A gap 30 between the fiber end surface 12 and the waveguide end surface 14 is filled with a filler 32 having substantially the same value of refractive index as that of refractive index of the fiber core 8.

### FIELD OF THE INVENTION

The present invention relates to an optical element combination structure and in particular to an optical element combination structure in which an optical fiber and an optical waveguide are combined with each other.

### BACKGROUND OF THE INVENTION

Conventionally, an optical element combination structure in which an optical fiber array and an optical waveguide are combined with each other and the fiber array is formed by fixing (a) tip(s) of (an) optical fiber(s) to a substrate has been known. (Please refer to, for example, Patent Publications 1 and 2 below). In this type of optical element combination structure such as disclosed in the Patent Publications 1 and 2, an end surface of the optical fiber array, namely, (an) end surface(s) of the optical fiber(s) and an end surface of the optical waveguide are opposed to each other and are perpendicular to an optical axis. In this case, there is a problem that light transmitted through the combination structure is reflected at the end surfaces of the fiber and the waveguide to cause a return light, namely, a light going back in the reverse direction to an input location so that, for example, a laser light source emitting resonance may suffer an adverse effect. To solve this problem, another type of optical element combination structure in which (an) end surface(s) of (an) optical fiber(s) and an end surface of an optical waveguide are opposed to each other and are inclined relative to an optical axis is known and this combination structure can reduce a return light. This latter type is now employed in many optical element combination structures.

Referring to FIG. 8, an example of the latter type of optical element combination structure will be explained. FIG. 8 is a cross-sectional front view of an optical element combination structure. As shown in FIG. 8, an optical element combination structure 50 has an array of optical fibers 52 extending to a fiber end surface 56 along an optical axis 50a and an optical waveguide 54 aligned with the optical fibers 52 in a direction of the optical axis 50a, and the waveguide 54 has a waveguide end surface 58 facing the fiber end surface 56. The fiber end surface 56 and the waveguide end surface 58 are formed so that they are inclined relative to the optical axis 50a and opposed to each other. A transparent resin 60 is filled between the fiber end surface 56 and the waveguide end surface 58 so that the array of the fibers 52 and the optical waveguide 54 are coupled to each other. The resin 60 is made of a material which is hardly deformed; namely, it has a relatively high elastic modulus so that an alignment between the axes of the array of the fibers 52 and the optical waveguide 54 is prevented from shifting.

When a light is transmitted from the array of the fibers 52 to the waveguide 54, the transmitted light is reflected at the fiber end surface 56 inclined relative to the optical axis 50a. Since the reflected light is directed obliquely relative to the optical axis 50a, most of the reflected light does not become a return light; namely, a light returning in the reverse direction along the optical axis 50a. Thus, a return light at the fiber end surface 56 can be reduced. Similarly, the transmitted light is directed obliquely relative to the optical axis 50a at the end surface 58 so that a return light at the waveguide end surface can be reduced.

Patent Publication 1: Japanese Patent Laid-open Publication No. 2002-107564 (Please refer to FIG. 1)

Patent Publication 2: Japanese Patent Laid-open Publication No. 2001-281479 (Please refer to Paragraph 0017 and FIG. 1)

### SUMMARY OF THE INVENTION

### Problem to be Solved

As stated above, the optical element combination structure 50 in which both of the fiber end surface 56 and the waveguide end surface 58 are inclined relative to the optical axis 50a provides an advantage that a return light at the end surfaces 56, 58 can be reduced, but there is a problem that the cost of manufacturing the combination structure 50 is very expensive.

Specifically, since the cost of manufacturing a waveguide 54 is substantially equal to the cost of manufacturing an array of the fibers 52, the cost of manufacturing a general combination structure 50 having one waveguide 54 and two arrays of fibers 52 connected to an input side and an output side of the waveguide 54 corresponds to triple the cost of manufacturing just the waveguide 54.

Further, it is considerably time-consuming and laborious to obliquely treat or cut an end surface of the fiber 52 or the array of the fibers 52 in a given angle and to align the fiber 52 or the array of the fibers 52 having the obliquely treated end surface with the waveguide 54 having an obliquely formed end surface to a submicron accuracy. Thus, a dedicated machine is actually necessary for obliquely treating the fiber 52 or the array of the fibers 52 and the waveguide 54 and aligning them with each other. The price of such a dedicated machine is more than 2000-10000 times the cost of manufacturing the waveguide 54 and thus a portion of this price, namely, the difference between the price of the dedicated machine and the waveguide 54, has to be added to the cost of manufacturing the combination structure 50.

Further, since an optical element combination structure in which an optical fiber and an optical waveguide are connected to each other is often used as an optical coupling or an optical splitter for an internet wiring network disposed outside, it is desired that a return light can be reduced enough even when an environment's temperature, namely, a temperature of the combination structure, changes.

It is therefore a first object of the present invention to provide a combined optical element structure, in which an optical fiber and an optical waveguide are combined with each other, and which can reduce a return light at an optical fiber end surface and an optical waveguide end surface, and can be manufactured at a low cost.

Further, it is second object of the present invention to provide a combined optical element structure, in which an optical fiber and an optical waveguide are combined with each other, and which can reduce a return light at an optical fiber end surface and an optical waveguide end surface even when an environment's temperature changes, and can be manufactured at low cost.

### SUMMARY OF THE INVENTION

To achieve the above-mentioned first object, the present invention provides an optical element combination structure, in which an optical fiber and an optical waveguide are combined with each other, comprising an optical fiber which extends to an optical fiber end surface in a direction of an optical axis and has an optical fiber core extending along the optical axis; an optical waveguide having an optical waveguide core aligned with the optical fiber core in the direction of the optical axis and an optical waveguide end surface facing the fiber end surface; and a substrate extending along the optical fiber and the optical waveguide in the direction of the optical axis, having a support surface which the optical fiber is supported on and secured to, and being integrally formed with the optical waveguide; the support surface being formed so that, when the optical fiber is abutted to the support surface, the optical fiber and the optical waveguide are in alignment with each other in the direction of the optical axis; a value of refractive index of the optical waveguide core being different from that of refractive index of the optical fiber core; the fiber end surface being formed substantially perpendicular to the optical axis; the waveguide end surface being formed so that it is inclined relative to a surface perpendicular to the optical axis; a gap being provided between the fiber end surface and the waveguide end surface and filled with an agent having a conditioned refractive index, namely, a filler having substantially the same value of refractive index as that of refractive index of the optical fiber core.

In this optical element combination structure, for example, a light is transmitted from the optical fiber through the filler to the optical waveguide. Since the value of refractive index of the core of the fiber is the same as that of refractive index of the filler, the transmitted light is not reflected at the fiber end surface; instead, it permeates the fiber end surface. Thus, a return light returning reversely along the optical axis does not arise at the fiber end surface. Further, since the waveguide end surface is inclined relative to a surface perpendicular to the optical axis, the light is reflected at the waveguide end surface and directed obliquely relative to the optical axis so that most of the reflected light does not become a return light; namely, a light returning reversely along the optical axis. Thus, such a return light at the waveguide end surface can be reduced. This similarly applies to a situation where a light is transmitted from the waveguide through the filler to the fiber.

In the optical element combination structure of the present invention, the fiber end surface can be formed substantially perpendicular to the optical axis by processing or cutting a tip of an optical fiber with a general-purpose cutter for optical fibers. Further, when a fiber having such a fiber end surface is supported by support surfaces of the substrate, the fiber and the waveguide are automatically aligned with each other. Therefore, comparing the present invention with the prior type optical element combination structure, the cost of manufacturing optical fiber arrays and the cost of the above-mentioned single purpose machine can be reduced. Additionally, by employing a filler having substantially the same value of refractive index as that of refractive index of the core of the optical fiber, an adverse effect to the reflective attenuation ratio caused by disposing the fiber end surface perpendicular to the optical axis can be reduced. Thus, return light at the fiber end surface and the waveguide end surface can be reduced, as well as the optical element combination structure being manufacturable at a low cost.

In the embodiment of the present invention, preferably, the fiber core is made of quartz and the value of refractive index of the filler is within a range of 1.428-1.486 while a temperature changes from −40° C. to +80° C.

In this optical element combination structure, even when a temperature changes from −40° C. to +80° C., a value of reflective attenuation ratio at the fiber end surface can be maintained equal to or smaller than −40 dB over the temperature change. As a result, even when a temperature changes, reduction of return light at the fiber end surface and the waveguide end surface can be ensured and the optical element combination structure can be manufactured at a low cost.

It should be noted that a value of a refractive index of the filler is that of a refractive index after the filler is cured.

In this embodiment of the present invention, while a temperature changes from −40° C. to +80° C., the value of refractive index of the filler is, more preferably, within a range of 1.441-1.473 and, much more preferably, within a range of 1.448-1.466.

In the embodiment in which the value of refractive index of the filler is within a range of 1.441-1.473, even when a temperature changes from −40° C. to +80° C., a value of reflective attenuation ratio at the fiber end surface can be maintained equal to or smaller than −45 dB over the range of the temperature change. In the embodiment in which the value of reflective index of the filler is within a range of 1.448-1.466, even when a temperature changes from −40° C. to +80° C., a value of reflective attenuation ratio at the fiber end surface can be maintained equal to or smaller than −50 dB over the range of temperature change.

In an embodiment of the present invention, preferably, the optical fiber is secured to the support surface of the substrate by an adhesive having elastic modulus which is enough to prevent the alignment between the optical fiber and the optical waveguide from shifting.

In this embodiment, since the alignment between the fiber and the waveguide is prevented from shifting by the adhesive, any resin can be selected as a filler, such as a resin which may cause alignment between the fiber and the waveguide to shift when only such a resin is used, and a resin which may cause separation from the fiber and/or waveguide, so that a value of reflective attenuation ratio can be reduced at the fiber end surface.

In the embodiment of the present invention, more preferably, the value of refractive index of the filler at the temperature +25° C. is equal to or smaller than 1.465.

Further, in an embodiment of the present invention, the optical fiber core is made of quartz and the filler has a value of coefficient of linear expansion equal to or smaller than 80 ppm/° C. and a value of refractive index of 1.452-1.461 at the temperature +25° C. In another embodiment of the present invention, the optical fiber core is made of quartz and the filler has a value of coefficient of linear expansion equal to or smaller than 60 ppm/° C. and a value of refractive index of 1.450-1.463 at the temperature +25° C. In another embodiment of the present invention, the optical fiber core is made of quartz and the filler has a value of coefficient of linear expansion equal to or smaller than 40 ppm/° C. and a value of refractive index of 1.449-1.466 at the temperature +25° C.

In each of these three embodiments, even when a temperature changes from −40° C. to +85° C., a value of reflective attenuation ratio at the fiber end surface can be substantially maintained equal to or smaller than −47 dB.

It should be noted that a value of a refractive index of the filler is that of a refractive index after the filler is cured.

Further, in the above three embodiments, preferably, the optical fiber is secured to the support surface of the substrate by an adhesive having elasticity modulus which is enough to prevent the alignment between the optical fiber and the optical waveguide from shifting.

In this embodiment, since the alignment between the fiber and the waveguide is prevented from shifting by the adhesive, any resin can be selected as a filler, such as a resin which may cause alignment between the fiber and the waveguide to shift when only such a resin is used, and a resin which may cause separation from the fiber and/or waveguide, so that a value of reflective attenuation ratio can be reduced at the fiber end surface.

In the embodiment of the present invention, preferably, the optical element combination structure further comprises an optical waveguide clad disposed around the optical waveguide core and an inclined angle of the waveguide end surface relative to a surface perpendicular to the optical axis is equal to or more than half of a total reflective angle defined by the optical waveguide core and clad.

In this optical element combination structure, for example, when a light enters the waveguide through the optical fiber and is reflected at the waveguide end surface, the light is not transmitted to the fiber. Thus, it is ensured that a return light at the waveguide end surface can be reduced. This similarly applies to a situation where a light travels from the waveguide to the fiber.

In the embodiment of the present invention, preferably, the inclined angle of the waveguide end surface relative to a surface perpendicular to the optical axis is 4-16 degrees.

In this optical element combination structure, a value of reflective attenuation ratio at the waveguide end surface can be substantially smaller than −40 dB.

In the embodiment of the present invention, preferably, the number of the optical waveguides is one and the number of the optical fibers is two and the optical fibers are disposed on the opposite sides of the optical waveguide in the direction of the optical axis and a value of reflective attenuation ratio of a light passing from one of the optical fibers through the optical waveguide to the other optical fiber is equal to or smaller than −40 dB.

In this optical element combination structure, a return light of the optical element combination structure such as an optical splitter and an optical coupler can be reduced and the optical element combination structure can be manufactured at a low cost.

As explained above, according to the present invention, an optical element combination structure can be provided, in which an optical fiber and an optical waveguide are combined with each other, and which can reduce a return light at a fiber end surface and a waveguide end surface, and can be manufactured at a low cost.

Further, according to the present invention, an optical element combination structure can be provided, in which an optical fiber and an optical waveguide are combined with each other, and which can reduce a return light at a fiber end surface and a waveguide end surface even when a temperature changes, and can be manufactured at low cost.

### BRIEF DESCRIPTION OF THE DRAWINGS

In the accompanying drawings:

FIG. 1 is a partially cross-sectional front view of an optical element combination which is an embodiment of the present invention;

FIG. 2 is a cross-sectional view taken along the line 2-2 in FIG. 1;

FIG. 3 is a schematic partial front view showing a relationship among an optical fiber end surface, an optical waveguide end surface and an optical axis;

FIG. 4 is a graph showing a relationship between a value of refractive index of a filler and a value of a reflective attenuation ratio when a fiber core is made of quartz;

FIG. 5 is a graph showing, in some values of coefficient of linear expansion of a filler, a relationship between a value of refractive index of the filler at the temperature +25° C. and a maximum value of reflective attenuation ratio of the filler while a temperature changes from −40° C. to +85° C. when an optical fiber core is made of quartz;

FIG. 6 is a graph showing a relationship between an inclined angle and a value of reflective attenuation ratio at an optical waveguide end surface;

FIG. 7 shows experimental values and calculation values of reflective attenuation ratio of fillers while a temperature changes from −40 to +80° C.; and

FIG. 8 is a cross-sectional front view of an optical element combination structure of prior art.

### DETAILED DESCRIPTION OF THE PREFERRED EMBODIMENTS

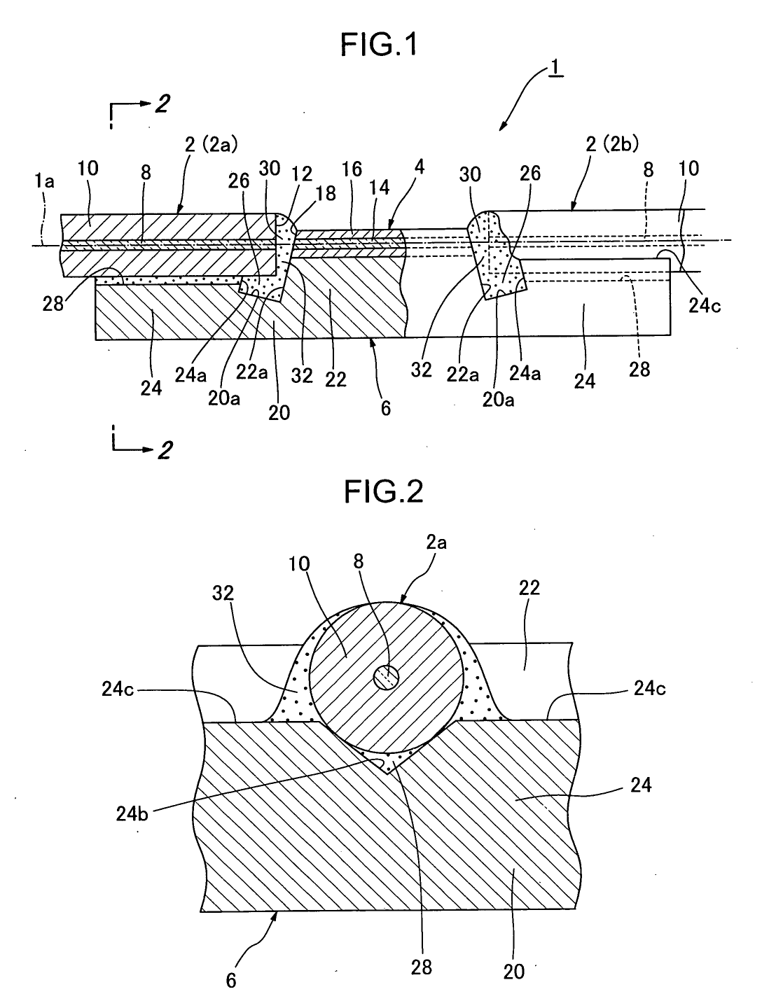

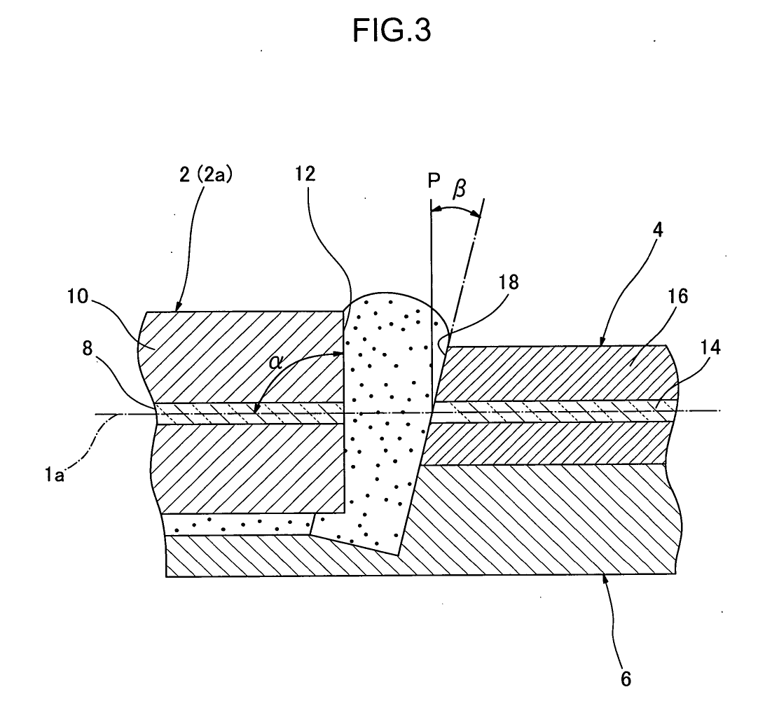

Referring to the drawings, an embodiment of an optical element combination structure according to the present invention will be explained in detail below. FIG. 1 is a partially cross-sectional front view of an optical element combination structure which is an embodiment of the present invention and has optical fibers and an optical waveguide and FIG. 2 is a cross-sectional view taken along the line 2-2 in FIG. 1. FIG. 3 is a schematic partial front view showing a relationship among an optical fiber end surface, an optical waveguide end surface and an optical axis.

It should be noted that, regarding values of refractive index, coefficient of linear expansion and elastic modulus of an adhesive and a filler described in this specification, they are values obtained after each of the adhesive and the filler is cured.

As shown in FIGS. 1 and 2, an optical element combination structure 1 has optical fibers 2 each extending in a direction of an optical axis 1a to a respective optical fiber end surface, an optical waveguide 4 aligned with the optical fibers 2 in the optical axis direction, and a substrate 6 extending along the optical fibers 2 and the optical waveguide 4 in the direction of the optical axis 1a.

The fibers 2 include an input optical fiber 2a disposed on an upstream or input side of the waveguide 4 and an output optical fiber 2b disposed on an downstream or output side of the waveguide 4. The input fiber 2a, the output fiber 2b and the waveguide 4 are arranged so that a light passing through the input fiber 2a is transmitted through the waveguide 4 to the output fiber 2b. The number of each of the input fiber 2a and the output fiber 2b can be one or more and, in the latter case, the fibers can be arranged laterally. For example, when the number of the input fibers 2a is one and the number of the output fibers 2b is plural, the combination structure 1 functions as an optical splitter, and when the number of the input fibers 2a is plural and the number of the output fibers 2b is one, the combination structure 1 functions as an optical coupler. Since an input-side structure of the combination structure 1 is similar to an output-side structure thereof, only the former will be explained below and an explanation of the latter will be omitted.

The input fiber 2a has an optical fiber core 8 extending along the optical axis 1a, an optical fiber clad 10 disposed around the fiber core 8 and an optical fiber end surface 12, namely, an end surface 12 on a waveguide side. The fiber end surface 12 is formed substantially perpendicular to the optical axis 1a. Specifically, as shown in FIG. 3, an inclined angle α from the optical axis 1a to the fiber end surface 12, which has a vertex at an intersection of the optical axis 1a and the fiber end surface 12 and is situated in a plane extending in an up-down direction and including the optical axis 1a, is preferably 85-95 degrees, more preferably, 85-92 degrees, much more preferably, 88-92 degrees. For example, a diameter of the fiber 2a is 125 μm. For example, the fiber core 8 is made of quartz.

The waveguide 4 has an optical waveguide core 14 aligned with the fiber core 8 in the direction of the axis 1a, an optical waveguide clad 16 arranged around the waveguide core 14 and an optical waveguide end surface 18, namely, an end surface 18 facing the fiber end surface 12. A value of the refractive index of the waveguide core 14 is preferably different from that of refractive index of the fiber core 8, but the former can be the same as the latter. As explained in detail later, the waveguide end surface 18 is formed so that it is inclined relative to the optical axis 1a. The waveguide end surface 18 is inclined so that it comes close to the fiber 2a as it extends downwardly.

The substrate 6 has a base portion 20 extending in the optical axis direction, a waveguide portion 22 extending upwardly from the base portion 20 toward the waveguide 4 and formed integrally with the waveguide 4 on an upper surface of the waveguide portion 22, and a fiber portion 24 which extends upwardly from the base portion 20 toward the fiber 2 for supporting the fiber 2 and is spaced apart from the waveguide portion 22. The waveguide portion 22 has a waveguide-side wall surface 22a connected to the waveguide end surface 18 and facing the fiber portion 24, and the fiber portion 24 has a fiber-side wall surface 24a facing the waveguide portion 22. A recess 26 is defined by the wall surfaces 22a, 24a and an upper surface 20a of the base portion 20 between the wall surfaces 22a, 24a. In the present embodiment, the waveguide-side wall surface 22a extends from the waveguide end surface 18 downwardly at the same inclined angle as that of the waveguide end surface 18, the upper surface 20a is formed perpendicular to the waveguide-side wall surface 22a, and the fiber-side wall surface 24a is formed parallel to the waveguide-side wall surface 22a, but any profiles of the recess 26 are allowed. For example, the waveguide-side wall surface 22a or the fiber-side wall surface 24a may extend perpendicular to the optical axis 1a, or the upper surface 20a may extend in the same direction as that of the optical axis 1a.

The fiber portion 24 has support surfaces 24b which the fiber 2 is supported on and secured to. The support surfaces 24b are formed so that, when the fiber 2 is abutted to the support surfaces 24b, the fiber 2 is in alignment with the waveguide 4 in the direction of the optical axis 1a. In the present embodiment, a groove 28 having a V-shaped cross-section is formed in an upper surface 24c of the fiber portion 24, which groove 28 extends in the direction of the optical axis 1a and opens upwardly. This groove 28 is formed so that, when the optical fiber 2 having a known outer diameter is abutted to the two surfaces of the groove 28, namely, the support surfaces 24b, the fiber 2 and the waveguide 4 are aligned with each other to a submicron accuracy. The profile of the support surfaces 24b, however, is not limited to this V-shaped cross section and thus is optional.

The fiber 2 is disposed on the support surfaces 24b so that the fiber end surface 12 is placed in the recess 26 and the fiber 2 is adhered to the support surfaces 24b by an adhesive and so on. This causes the fiber 2 to be aligned with the waveguide 4. A gap 30 is formed between the fiber end surface 12 perpendicular to the optical axis 1a and the waveguide end surface 18 inclined relative to the optical axis 1a. The fiber end surface 12 and the waveguide end surface 18 are preferably as close to each other as possible, but for facilitating automatically assembling of the fiber 2a, a gap of about 10-20 μm is actually provided between the waveguide end surface 18 and a portion of the fiber end surface 12 which is closest to the waveguide end surface 18.

The adhesive for securing the fiber 2 to the support surfaces 24b is preferably an adhesive whose elastic modulus is large enough to prevent the alignment between the fiber 2 and the waveguide 4 from shifting, but an adhesive whose elastic modulus is too large is not preferable because such an adhesive tends to easily separate from the fiber 2 and/or the waveguide 4 due to stress in the adhesive. Specifically, a value of elastic modulus of the adhesive is preferably 2.0-3.0 GPa. Such an adhesive is, for example, an ultraviolet curing type epoxy resin “WR8774” (The value of elastic modulus thereof is 2.5 GPa) manufactured by Kyoritsu Chemical Co. Ltd.

The recess 26 and the gap 30 are filled with a filler 32. It is necessary for the filler 32 to be transparent relative to a light because a light is transmitted from the fiber 2 through the filler 32 to the waveguide 4. Further, it is preferable that a value of refractive index of the filler 32 be substantially the same as that of refractive index of the fiber core 8.

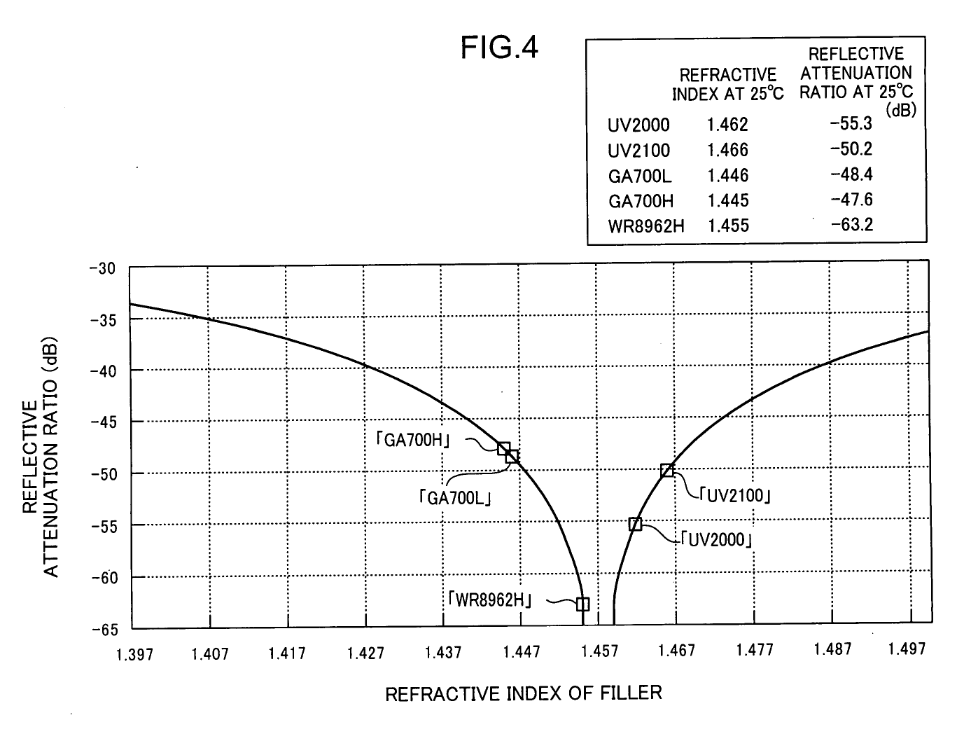

Referring to FIG. 4 and Table 1, preferable values of refractive index of the filler 32 will be explained. FIG. 4 and Table 1 are respectively a graph and a table showing a relationship between a value of refractive index of the filler 32 and a value of a reflective attenuation ratio when the fiber core 8 is made of quartz (The value of refractive index thereof is 1.457). The reflective attenuation ratio (10 log₁₀ (Pr/Pi)) is a ratio, in a decibel unit, of a power of a light (Pr) reflected at a boundary face between the fiber 2 and the filler 32, namely, the fiber end surface 12 with respect to a power of an input light (Pi) when a light from the fiber 2 enters the filler 32 adjacent thereto or when a light from the filler 32 enters the fiber 2. This means that the smaller a value of reflective attenuation ratio is, namely, the more it goes in the minus direction, the less a return light at the fiber end surface 12 is.

TABLE 1

| Reflective Attenuation Ratio | Reflective Index of Filler |
|---|---|
| Equal to or smaller than −40 dB | 1.428˜1.486 |
| Equal to or smaller than −41 dB | 1.431˜1.483 |
| Equal to or smaller than −42 dB | 1.434˜1.480 |
| Equal to or smaller than −43 dB | 1.437˜1.478 |
| Equal to or smaller than −44 dB | 1.439˜1.476 |
| Equal to or smaller than −45 dB | 1.441˜1.473 |
| Equal to or smaller than −46 dB | 1.442˜1.472 |
| Equal to or smaller than −47 dB | 1.444˜1.470 |
| Equal to or smaller than −48 dB | 1.445˜1.469 |
| Equal to or smaller than −49 dB | 1.447˜1.467 |
| Equal to or smaller than −50 dB | 1.448˜1.466 |

In order to reduce such a return light, the value of reflective attenuation ratio is preferably equal to or smaller than −40 dB, which is a general requirement; further, it is preferably as small as possible, and it is more preferably equal to or smaller than −50 dB, which is a severer requirement. As shown in Table 1 and FIG. 4, for example, the value of refractive index of the filler 32 is preferably within 1.428-1.486 to satisfy a condition where the value of reflective attenuation ratio is substantially equal to or smaller than −40 dB, and the value of refractive index of the filler 32 is more preferably within 1.448-1.466 to satisfy a condition where the value of reflective attenuation ratio is substantially equal to or smaller than −50 dB, which is a severer requirement. When the value of reflective attenuation ratio is converted into a ratio of the value of refractive index of the filler 32 with respect to 1.457, namely, the value of refractive index of the quartz, the converted ratio is preferably within 0.98-1.02 to satisfy the value of reflective attenuation ratio substantially equal to or smaller than −40 dB, and the converted ratio is more preferably within 0.994-1.006 to satisfy the value of reflective attenuation ratio substantially equal to or smaller than −50 dB which is a severer requirement. Further, while a temperature changes from −40° C. to +85° C., the value of refractive index of the filler 32 is preferably within a range of the value of refractive index shown in Table 1 corresponding to a desired value of reflective attenuation ratio. Such a desired value of reflective attenuation ratio is preferably as smaller as possible. For example, to satisfy a condition where the value of reflective attenuation ratio is substantially equal to or smaller than −50 dB while a temperature changes from −40° C. to +85° C., the value of refractive index of the filler 32 is preferably within a range 1.448-1.466.

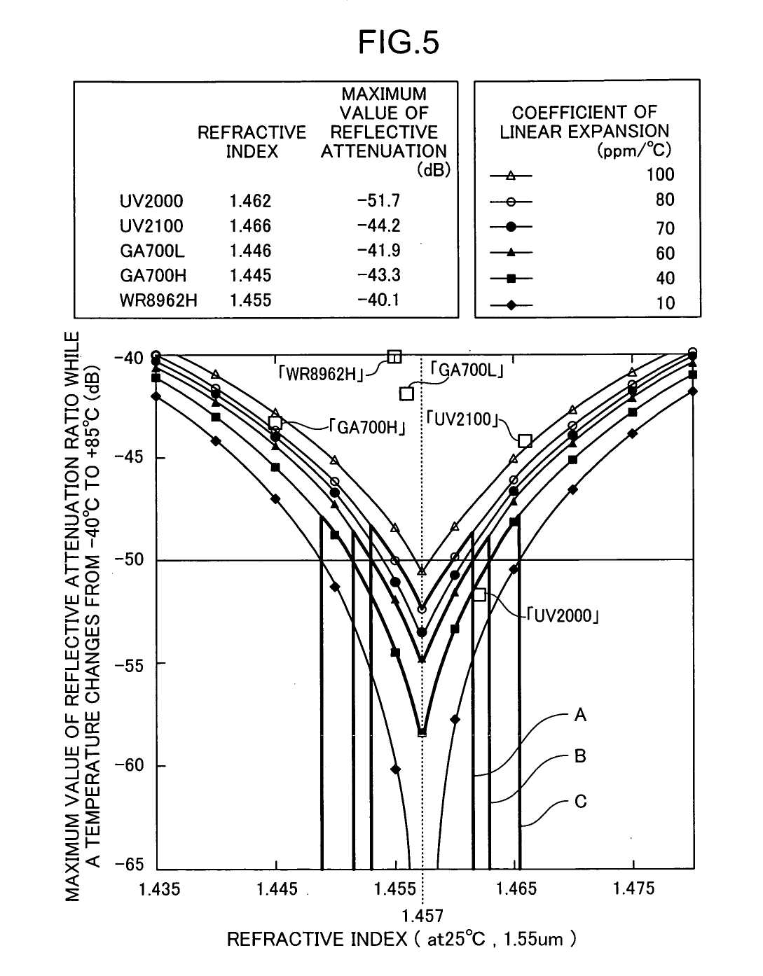

FIG. 5 is a graph showing, in some values of coefficient of linear expansion of the filler 32, a relationship between a value of refractive index of the filler 32 at the temperature +25° C. and a maximum value of reflective attenuation ratio of the filler 32 (the largest value in the plus direction, namely, a reflective attenuation ratio when the return light is reduced as much as possible) while a temperature changes from −40° C. to +85° C. when the optical fiber core is made of quartz. As seen from FIG. 5, regarding fillers having the same value of refractive index at the temperature +25° C., when a value of coefficient of linear expansion of the filler becomes larger, a maximum value of the reflective attenuation ratio of the filler while a temperature changes from −40° C. to +85° C. shifts in the plus direction.

FIG. 4 is obtained by using the following equations (1) and (2);
dn/dt=−3a×(n25−1) equation (1);
R=−10×log₁₀{(n−1.457)2/(n+1.457)2} equation (2);
wherein n is a value of refractive index of the filler at a given temperature, n25 is a value of refractive index of the filler at +25° C., a is a value of coefficient of linear expansion of the filler, R is a value of reflective attenuation ratio and t is a temperature.

As shown in a range surrounded by bold lines A in FIG. 5, preferably, the filler 32 has a value of coefficient of linear expansion equal to or smaller than 80 ppm/° C. and a value of refractive index within 1.452-1.461 at +25° C. Also, as shown in a range surrounded by bold lines B in FIG. 5, preferably, the filler 32 has a value of coefficient of linear expansion equal to or smaller than 60 ppm/° C. and a value of refractive index within 1.450-1.463 at +25° C. Also, as shown in a range surrounded by bold lines C in FIG. 5, preferably, the filler 32 has a value of coefficient of linear expansion equal to or smaller than 40 ppm/° C. and a value of refractive index within 1.449-1.466 at +25° C.

Further, the filler 32 preferably has a value of refractive index equal to or smaller than 1.465 at +25° C.

The filler 32 is preferably acrylic resin, epoxy resin, silicone resin and so on of an optic curing type, a thermal curing type, a room temperature curing type or a cation curing type. Particular examples of these resins are a fluorinated epoxy compound described in Table 1 on page 90 of “Development and Application Technology of Optoelectronics Material” issued by Technical Information Society Co, Ltd. on Feb. 9, 2001, fluorinated epoxy acrylate compound described in Table 2 on page 91 of the same, and a cation curing type silicone resin described in Japanese Patent Laid-open Publication No. 2004-196977.

More specifically, the epoxy resin is preferably one having a fluorinated epoxy compound represented by Formula 1 as a main component. It is particularly preferable that Rf in Formula 1 be one represented by Formula 2 or 3 and n in Formula 1 be within 0.1-1.0.

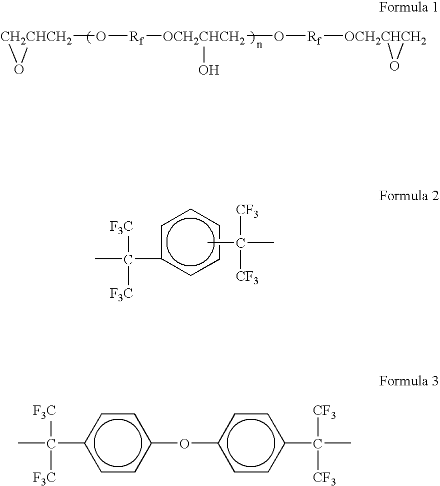

The acrylic resin is preferably one having a fluorinated epoxy acrylate represented by Formula 4 as a main component. It is particularly preferable that Rf in Formula 4 be one represented by Formula 3 and n in Formula 4 be within 0.1-1.0.

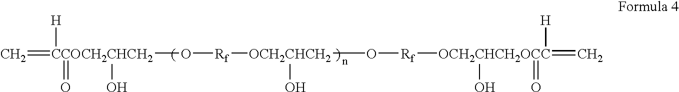

Particular examples of commercial products of the filler 32 include an ultraviolet curing type acrylic resin “UV2000” (The value of elastic modulus thereof is 1.1 GPa, the value of refractive index thereof with respect to a light having a wave length of 1.55 μm at +25° C. is 1.462, the value of coefficient of linear expansion thereof is 311 ppm/° C.; and the value of viscosity thereof is 360 mPa·s) manufactured by Daikin Industries Ltd. and having a main component of a fluorinated epoxy acrylate represented by Formula 4 in which Rf is represented by Formula 3. Conventionally the resin “V2000” has not been used for this application because, when only the resin “UV2000” is disposed between the fiber 2 and the waveguide 4, alignment between the fiber 2 and the waveguide 4 may shift. As shown in FIG. 5, the resin “UV2000” can maintain a value of reflective attenuation ratio smaller than −50 dB while a temperature changes from −40° C. to +85° C.

Other particular examples of commercial products of the filler 32 include an ultraviolet curing type epoxy resin “UV2100” (The value of elastic modulus thereof is 2.4 GPa, the value of refractive index thereof with respect to a light having a wave length of 1.55 μm at +25° C. is 1.466, the value of coefficient of linear expansion thereof is 107 ppm/° C.; and the value of viscosity thereof is 250 mPa·s) manufactured by Daikin Industries Ltd. and having a main component of fluorinated epoxy compound represented by Formula 1 in which Rf is represented by Formula 3; an ultraviolet curing type epoxy resin “GA700L” (The value of elastic modulus thereof is 0.4 GPa, the value of refractive index thereof with respect to a light having a wave length of 1.55 μm at +25° C. is 1.446, the value of coefficient of linear expansion thereof is 140 ppm/° C.; and the value of viscosity thereof is 250 mPa·s) manufactured by NTT-AT Corporation and having a main component of a fluorinated epoxy compound represented by Formula 1 in which Rf is represented by Formula 2; an ultraviolet curing type epoxy resin “GA700H” (The value of elastic modulus thereof is 1.0 GPa, the value of refractive index thereof with respect to a light having a wave length of 1.55 μm at +25° C. is 1.445, the value of coefficient of linear expansion thereof is 90 ppm/° C.; and the value of viscosity thereof is 252 mPa·s) manufactured by NTT-AT Corporation having a main component of fluorinated epoxy compound represented by Formula 1 in which Rf is represented by Formula 2; and a cation curing type silicone resin “WR8962H” (The value of elastic modulus thereof is 5.0 GPa, the value of refractive index thereof with respect to a light having a wave length of 1.55 μm at +25° C. is 1.455, the value of coefficient of linear expansion thereof is 300 ppm/° C.; and the value of viscosity thereof is 2800 mPa·s) manufactured by Kyoritsu Chemical & Co., Ltd. Conventionally the resins “GA700L” and “GA700H” have not been used for this application because, when only each of the resins “GA700L” and “GA700H” is disposed between the fiber 2 and the waveguide 4, alignment between the fiber 2 and the waveguide 4 may shift. Also, conventionally the resin “WR8962H” has not been used for this application because, when only the resin “WR8962H” is disposed between the fiber 2 and the waveguide 4, the resin “WR8962H” may be separated therefrom due to stress thereon. As shown in FIG. 4, the values of reflective attenuation ratio of these four fillers at +25° C. are all equal to or smaller than −48 dB. Further, as can be seen from FIG. 5, while a temperature changes from −40° C. to +85° C., these four fillers do not maintain the value of reflective attenuation ratio equal to or smaller than −50 dB, but the resins “UV2100”, “GA700L”, “GA700H” and “WR8962H” can respectively maintain the value of reflective attenuation ratio equal to or smaller than −44 dB, −41 dB, −43 dB and −40 dB.

Next, referring to FIG. 3, the inclined angle of the waveguide end face 18 will be explained in detail. As shown in FIG. 3, the inclined angle β of the waveguide end face 18 is an angle from a surface P perpendicular to the axis 1a to the waveguide end face 18, which angle has a vertex at an intersection of the optical axis 1a and the waveguide end surface 18 and is situated in a plane extending in an up-down direction and including the optical axis 1a. For example, the inclined angle β of the waveguide end face 18 is preferably equal to or more than a half of a total reflection angle (cos⁻¹ (n2/n1)) defined by the optical waveguide core 14 (The value of refractive index thereof is n1) and the optical waveguide clad 16 (The value of refractive index thereof is n2) so that, when a light from the fiber 2 enters the waveguide 4 and a portion of the light is reflected at the waveguide end face 18, the portion of the light is prevented from being transmitted to the fiber 2. For example, the inclined angle β is preferably equal to or more than 5.7 degrees when the values of refractive index of the core 14 and the clad 16 are respectively 1.53 and 1.50. This similarly applies to a situation where a light from the waveguide 4 travels to the fiber 2.

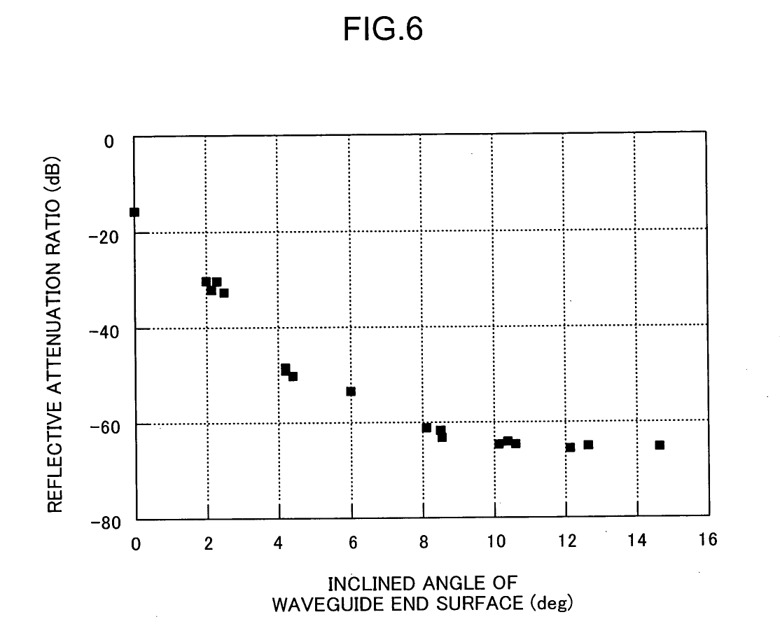

Further, FIG. 6 is a graph showing a relationship between the inclined angle β and the value of reflective attenuation ratio at the waveguide end face 18. The reflective attenuation ratio (10 log₁₀ (Pr/Pi)) is a ratio, in a decibel unit, of a power of a light (Pr) reflected at the waveguide end face 18 with respect to a power of an input light (Pi) when a light from the fiber 2 enters the waveguide 4 or when a light from the waveguide 4 travels to the fiber 2. This means that the smaller a value of reflective attenuation ratio is, the smaller a return light at the waveguide end surface 18 is. As shown in FIG. 6, the inclined angle β of the waveguide end face 18 is preferably within 6-16 degrees to satisfy a value of reflective attenuation ratio equal to or smaller than −40 dB which is a general requirement, and is preferably within 4-16 degrees to satisfy a value of reflective attenuation ratio equal to or smaller than −50 dB which is a severer requirement. Further, taking into consideration that it is better for a gap between the fiber end face 12 and the waveguide end face 18 to be short, the inclined angle β of the waveguide end face 18 is more preferably within 6-10 degrees.

As mentioned above, the optical element combination structure 1 has one optical waveguide 4 and two optical fibers 2a, 2b arranged on opposite sides of the waveguide 4 in the direction of the optical axis 1a and thus the combination structure 1 is such as a waveguide-type optical splitter or coupler. Regarding the whole combination structure 1, a value of reflective attenuation ratio of a light transmitted from the one fiber 2a through the waveguide 4 to the other fiber 2b is preferably smaller than −40 dB and more preferably smaller than −50 dB.

Now, an operation carried out by the optical element combination structure which is an embodiment of the present invention will be explained. Since the value of refractive index of the fiber core 8 is substantially the same as that of refractive index of the filler 32, a light transmitted through the input fiber 2a is not reflected at the fiber end surface 12 of the input fiber 2a; instead it permeates the fiber end surface 12 without any changes so that no return light arises at the fiber end surface 12. The light is transmitted through the filler 32 and it is reflected at the waveguide end surface 18. Since the waveguide end surface 18 is inclined relative to a surface perpendicular to the axis 1a, the light is obliquely reflected relative to the optical axis 1a. Since the reflected light is directed obliquely relative to the optical axis 1a, most of the reflected light does not become a return light, namely, a light returning along the optical axis 1a in the reverse direction. Thus, the return light arising at the waveguide end surface 18 is reduced remarkably. Then, the light is transmitted through the waveguide 4 and reflected at the waveguide end surface 18 on the output-fiber side. Since the reflected light is also obliquely directed relative to a surface perpendicular to the optical axis 1a, most of the reflected light does not become a return light returning along the optical axis 1a in the reverse direction. Thus, the return light arising at the waveguide end surface 18 is reduced remarkably. Since the value of refractive index of the fiber core 8 of the output fiber 2b is substantially the same as that of refractive index of the filler 32, a light going through the filler 32 on the output-fiber side is not reflected at the fiber end surface 12 of the output fiber 2b; instead it permeates the fiber end surface 12 without any changes so that no return light arises at the fiber end surface 12.

Next, an example of a way of manufacturing an optical element combination structure 1 which is an embodiment of the present invention will be explained. A substrate 6 made of material such as silicon and polymer material is prepared and, by anisotropic etching the substrate 6 according to a resist pattern formed by means of photolithography, the substrate 6 is formed with grooves 28 each having a V-shaped cross section. Then, the substrate 6 having the V-shaped cross-sectional grooves 28 is formed with an optical waveguide 4. Particularly, in case a waveguide 4 is made of polymer material, after a clad layer 16 and a core layer on the clad layer 16 are formed by spin coating or molding, a waveguide core 14 having a rectangular cross section is formed from the core layer by means of a process such as photo lithography and reactive ion etching or by means of a machining process such as crimping. Then, a further clad layer 16 is formed in a manner similar to the forming way mentioned above to cover the waveguide core 14 so that a waveguide 4 is formed. Also, in case a waveguide 4 is made of quartz, after a quartz layer is formed on the substrate 6 by means of a process such as flame hydrate deposition and CVD, a quartz core 14 having a rectangular cross section is formed by means of a process such as dry etching and then clad layer 16 is formed to cover the quartz core 14 so that a waveguide 4 is formed. The steps of forming V-shaped cross-sectional grooves 28 and forming waveguide 4 are performed so that a positional relationship between the support surfaces 24b and the waveguide 4 is obtained, namely, when the fiber 2 is placed on the support surfaces 24b of the groove 28, the fiber 2 and the optical waveguide 4 are aligned with each other to a submicron accuracy. Then, a waveguide end face 18 and a recess 26 are formed by means of dicing and so on. When the recess 26 has a profile according to the above-mentioned embodiment of the present invention, the waveguide end face 18 and the recess 26 can be formed at one time. Then, the fiber 2 is arranged on the support surfaces 24b so that the fiber end surface 12 is situated in the recess 26 and the fiber 2 is adhered to the support surfaces 24b by means of an adhesive and so on. This allows the fibers 2 and the waveguide 4 to be aligned with each other. Then, a gap 30 between the fiber end surface 12 and the waveguide end surface 18 and the recess 26 are filled with a filler 32 so that the fiber 2 is coupled to the waveguide 4.

Next, how to measure values of refractive index, coefficient of linear expansion and elastic modulus of the filler and the adhesive will be explained.

First, how a value of refractive index of, for example, the filler was measured will be explained. Regarding the refractive index of the filler, a value of refractive index of a film-shaped filler on a silicon wafer was measured by using a measurement equipment “Model 2010 Prism Coupler” manufactured by Metricon Corporation. Specifically, for example, after the filler was formed on a silicon wafer by spin coating to form a film-shaped filler having a given film thickness, the film-shaped filler was cured by means of ultraviolet rays. The given film thickness was determined so that a film thickness of the cured filler was 0.5-15 μm. Actually, the film thickness of the cured filler was 1-5 μm. An ultraviolet ray having a wavelength of 365 nm and strength of 100 mW was used. A dose of the ray was 20 J/cm² when an ultraviolet curing type epoxy resin “UV2100” manufactured by Daikin Industries Ltd., an ultraviolet curing type acrylic resin “UV200” manufactured by Daikin Industries Ltd. and an ultraviolet curing type epoxy resin “GA700H” manufactured by NTT-AT Corporation were measured. Further, a dose of the ray was 5 J/cm² when an ultraviolet curing type epoxy resin “GA700L” manufactured by NTT-AT Corporation and a cation curing type silicone resin “WR8962H” manufactured by Kyoritsu Chemical & Co., Ltd were measured. Then, a value of refractive index of the cured film-shaped filler was measured by means of the above-mentioned measurement equipment. This measurement equipment is an apparatus for measuring a value of refractive index, which apparatus is operated in such a way that a prism having a light refractive index is made to approach to the film-shaped filler in a state of sandwiching a thin air layer between the prism and the film-shaped filler, and adjusting an angle of a light beam entering the prism so that the light beam is vibrated in the film-shaped filler, Next, how a value of coefficient of linear expansion of, for example, a filler was measured will be explained. The value of coefficient of linear expansion was measured by using the TMA (thermal machine analysis) method. The measurement condition was pull mode of 5° C. per a minute. A temperature was changed from 20° C. to 100° C. When the temperature was 25° C., a value of coefficient of linear expansion was measured and such a value is described in this specification.

Next, how a value of elastic modulus of, for example, a filler was measured will be explained. A value of elastic modulus was measured in accordance with JIS (Japanese Standards Association)-K7127, namely, “a tension test of plastic film and sheet”.

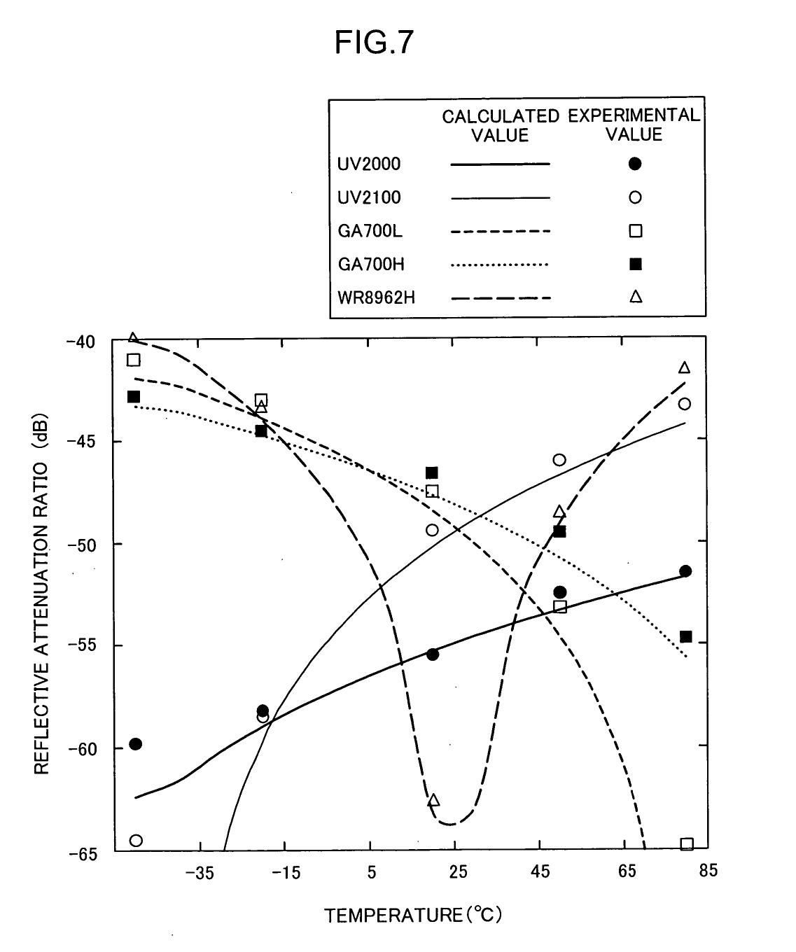

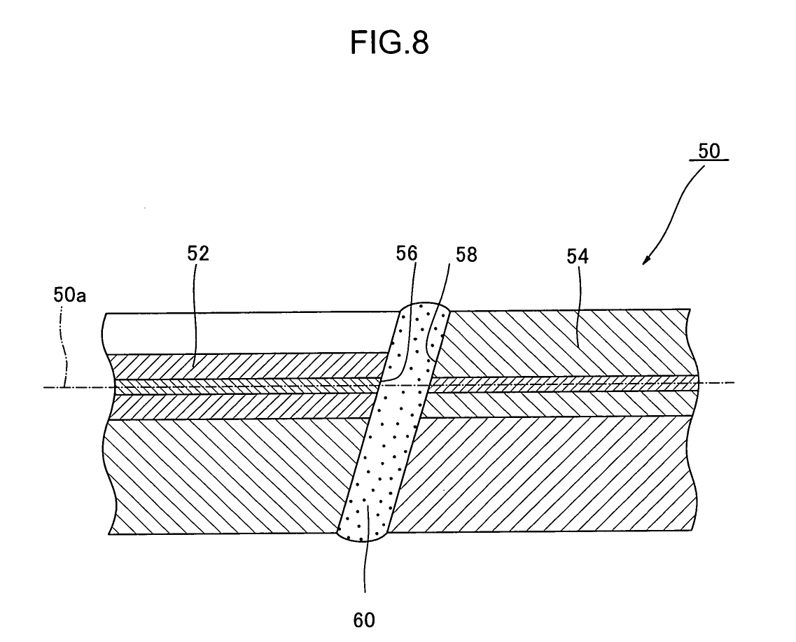

Practical experiments regarding the above-mentioned embodiment will now be explained. As a substrate 6, a silicon was employed which is a single crystal and is easy to anisotropic etch. An optical waveguide 4 made of fluorinated polyimide (OPI manufactured by Hitachi Chemical Co., Ltd.) was formed on the substrate 6. The values of refractive index of the waveguide core 14 and the waveguide clad 16 were respectively 1.53 and 1.52. Thus, a half of the total reflection angle was 3.28 degrees. Since machining accuracy by means of dicing was estimated at plus or minus two degrees, the waveguide end surface 18 was machined by means of dicing so that the inclined angle β thereof was 6 degrees. The optical fibers were made of quartz. Thus, the value of refractive index of quartz with respect to a light having a wavelength of 1.31 μm was 1.468. The experiments regarding a filler were performed by using an ultraviolet curing type acrylic resin “UV2000” manufactured by Daikin Industries Ltd., an ultraviolet curing type epoxy resin “UV2100” manufactured by Daikin Industries Ltd., an ultraviolet curing type epoxy resin “GA700L” manufactured by NTT-AT Corporation, an ultraviolet curing type epoxy resin “GA700H” manufactured by NTT-AT Corporation, and a cation curing type silicone resin “WR8962H” manufactured by Kyoritsu Chemical & Co., Ltd. Table 2 shows respective experimental values of reflective attenuation ratio of these fillers 32 at −40° C., −15° C., +25° C., +55° C. and +85° C. Further, FIG. 7 shows these experimental values of reflective attenuation ratio of the fillers and lines obtained by calculating the equations (1) and (2) under the condition in which a temperature changes from −40° C. to +85° C. An apparatus “AQ2140-AQ7310” manufactured by Ando Electric Incorporatiod Company was used for measuring a value of reflective attenuation ratio.

TABLE 2

| | Reflective Attenuation Ratio (dB) | | | | |
|---|---|---|---|---|---|
| Filler | −40° C. | −15° C. | +25° C. | +55° C. | +85° C. |
| UV2000 | −59.8 | −58.2 | −55.5 | −52.5 | −51.5 |
| UV2100 | −64.5 | −58.5 | −49.4 | −46.0 | −43.3 |
| GA700L | −41.0 | −43.0 | −47.5 | −53.2 | −64.8 |
| GA700H | −42.8 | −44.5 | −46.6 | −49.5 | −54.7 |
| WR8962H | −40.1 | −43.5 | −62.8 | −48.7 | −41.7 |

Although an optical element combination structure including optical fibers and an optical waveguide which is an embodiment in accordance with the present invention was explained above, the present invention is not limited by this embodiment and any modification can be made within the scope of the invention defined in the claims. Of course, such modifications fall within the scope of the present invention.

The materials used in the embodiments of the present invention are only exemplary and any materials can be used so far as they meet the requirements defined in the claims of the present invention.

1. An optical element combination structure in which an optical fiber and an optical waveguide are combined with each other comprising:
an optical fiber which extends to an optical fiber end surface in a direction of an optical axis and has an optical fiber core extending along the optical axis;
an optical waveguide having an optical waveguide core aligned with the optical fiber core in the direction of the optical axis and an optical waveguide end surface facing the fiber end surface; and
a substrate extending along the optical fiber and the optical waveguide in the direction of the optical axis, having a support surface which the optical fiber is supported on and secured to, and integrally formed with the optical waveguide;
wherein the support surface is formed so that, when the optical fiber is abutted to the support surface, the optical fiber and the optical waveguide are in alignment with each other in the direction of the optical axis;
wherein a value of refractive index of the optical waveguide core is different from that of refractive index of the optical fiber core;
wherein the fiber end surface is formed substantially perpendicular to the optical axis, and the waveguide end surface is formed so that it is inclined relative to a surface perpendicular to the optical axis; and
wherein a gap is provided between the fiber end surface and the waveguide end surface and is filled with a filler having substantially the same value of refractive index as that of refractive index of the optical fiber core.

2. An optical element combination structure according to claim 1, wherein the fiber core is made of quartz and wherein the value of refractive index of the filler is within a range of 1.428-1.486 while a temperature changes from −40° C. to +80° C.

3. An optical element combination structure according to claim 2, wherein the value of refractive index of the filler is within a range of 1.441-1.473 while a temperature changes from −40° C. to +80° C.

4. An optical element combination structure according to claim 3, wherein the value of refractive index of the filler is within a range of 1.448-1.466 while a temperature changes from −40° C. to +80° C.

5. An optical element combination structure according to claim 2, wherein the optical fiber is secured to the support surface of the substrate by an adhesive having an elastic modulus which is enough to prevent the alignment between the optical fiber and the optical waveguide from shifting.

6. An optical element combination structure according to claim 2, wherein the value of refractive index of the filler at the temperature +25° C. is equal to or smaller than 1.465.

7. An optical element combination structure according to claim 1, wherein the optical fiber core is made of quartz and wherein the filler has a value of coefficient of linear expansion equal to or smaller than 80 ppm/° C. and a value of refractive index of 1.452-1.461 at the temperature +25° C.

8. An optical element combination structure according to claim 1, wherein the optical fiber core is made of quartz and wherein the filler has a value of coefficient of linear expansion equal to or smaller than 60 ppm/° C. and a value of refractive index of 1.450-1.463 at the temperature +25° C.

9. An optical element combination structure according to claim 1, wherein the optical fiber core is made of quartz and wherein the filler has a value of coefficient of linear expansion equal to or smaller than 40 ppm/° C. and a value of refractive index of 1.449-1.466 at the temperature +25° C.

10. An optical element combination structure according to claim 7, wherein the optical fiber is secured to the support surface of the substrate by an adhesive having an elasticity modulus which is enough to prevent the alignment between the optical fiber and the optical waveguide from shifting.

11. An optical element combination structure according to claim 1, further comprising an optical waveguide clad disposed around the optical waveguide core, and wherein an inclined angle of the waveguide end surface relative to a surface perpendicular to the optical axis is equal to or more than half of a total reflective angle defined by the optical waveguide core and clad.

12. An optical element combination structure according to claim 1, wherein the inclined angle of the waveguide end surface relative to a surface perpendicular to the optical axis is 4-16 degrees.

13. An optical element combination structure according to claim 1, wherein the number of the optical waveguides is one and the number of the optical fibers is two and the optical fibers are disposed on the opposite sides of the optical waveguide in the direction of the optical axis, and wherein a value of reflective attenuation ratio of a light passing from one of the optical fibers through the optical waveguide to the other optical fiber is equal to or smaller than −40 dB.

14. An optical element combination structure according to claim 10, further comprising an optical waveguide clad disposed around the optical waveguide core and wherein an inclined angle of the waveguide end surface relative to a surface perpendicular to the optical axis is equal to or more than a half of a total reflective angle defined by the optical waveguide core and clad.

15. An optical element combination structure according to claim 10, wherein the inclined angle of the waveguide end surface relative to a surface perpendicular to the optical axis is 4-16 degrees.

16. An optical element combination structure according to claim 10, wherein the number of the optical waveguide is one and the number of the optical fiber is two and the optical fibers are disposed on the opposite sides of the optical waveguide in the direction of the optical axis and wherein a value of reflective attenuation ratio of a light passing from one of the optical fibers through the optical waveguide to the other optical fiber is equal to or smaller than −40 dB.

17. An optical element combination structure according to claim 2, further comprising an optical waveguide clad disposed around the optical waveguide core, and wherein an inclined angle of the waveguide end surface relative to a surface perpendicular to the optical axis is equal to or more than half of a total reflective angle defined by the optical waveguide core and clad.

18. An optical element combination structure according to claim 5, further comprising an optical waveguide clad disposed around the optical waveguide core, and wherein an inclined angle of the waveguide end surface relative to a surface perpendicular to the optical axis is equal to or more than half of a total reflective angle defined by the optical waveguide core and clad.

19. An optical element combination structure according to claim 7, further comprising an optical waveguide clad disposed around the optical waveguide core, and wherein an inclined angle of the waveguide end surface relative to a surface perpendicular to the optical axis is equal to or more than half of a total reflective angle defined by the optical waveguide core and clad.

20. An optical element combination structure according to claim 2, wherein the inclined angle of the waveguide end surface relative to a surface perpendicular to the optical axis is 4-16 degrees.

21. An optical element combination structure according to claim 5, wherein the inclined angle of the waveguide end surface relative to a surface perpendicular to the optical axis is 4-16 degrees.

22. An optical element combination structure according to claim 7, wherein the inclined angle of the waveguide end surface relative to a surface perpendicular to the optical axis is 4-16 degrees.

23. An optical element combination structure according to claim 2, wherein the number of the optical waveguides is one and the number of the optical fibers is two and the optical fibers are disposed on the opposite sides of the optical waveguide in the direction of the optical axis, and wherein a value of reflective attenuation ratio of a light passing from one of the optical fibers through the optical waveguide to the other optical fiber is equal to or smaller than −40 dB.

24. An optical element combination structure according to claim 5, wherein the number of the optical waveguides is one and the number of the optical fibers is two and the optical fibers are disposed on the opposite sides of the optical waveguide in the direction of the optical axis, and wherein a value of reflective attenuation ratio of a light passing from one of the optical fibers through the optical waveguide to the other optical fiber is equal to or smaller than −40 dB.

25. An optical element combination structure according to claim 7, wherein the number of the optical waveguides is one and the number of the optical fibers is two and the optical fibers are disposed on the opposite sides of the optical waveguide in the direction of the optical axis, and wherein a value of reflective attenuation ratio of a light passing from one of the optical fibers through the optical waveguide to the other optical fiber is equal to or smaller than −40 dB.
